(19) United States
(12) Patent Application Publication
(10) Pub. No.: US 2017/0366799 A1
(43) Pub. Date: Dec. 21, 2017

(54) STEREOSCOPIC AERIAL-VIEW IMAGES

(71) Applicant: BitAnimate, Inc., Lake Oswego, OR (US)

(72) Inventors: Behrooz Maleki, West Linn, OR (US); Sarvenaz Sarkhosh, West Linn, OR (US)

(21) Appl. No.: 15/187,418

(22) Filed: Jun. 20, 2016

(51) Int. Cl. H04N 13/02; H04N 5/232

(52) U.S. Cl. CPC H04N 13/0207; H04N 5/23293

(57) ABSTRACT

According to an aspect of an embodiment, a method may include obtaining a first digital image that depicts a first aerial view of a first area of a setting. The method may additionally include obtaining a second digital image that depicts a second aerial view of a second area of the setting. Further, the method may include determining an overlapping area where the first area and the second area overlap and obtaining a third digital image based on the overlapping area, the first digital image, and the second digital image. In addition, the method may include generating a stereoscopic image of the setting based on the first digital image and the third digital image.

### FIELD

The present disclosure relates to rendering stereoscopic images with respect to mapping services.

### BRIEF DESCRIPTION OF THE DRAWINGS

Example embodiments will be described and explained with additional specificity and detail through the use of the accompanying drawings in which:

FIG. 1 illustrates an example system 100 for generating stereoscopic (3D) images;

FIG. 2A illustrates example monoscopic digital images that may be used to generate a stereoscopic image;

FIG. 2B illustrates an example field-of-view and position of a camera with respect to the digital images of FIG. 2A;

FIG. 2C illustrates example areas that may be depicted by digital images associated with the camera being positioned as indicated in FIG. 2B;

FIG. 2D illustrates overlapping areas of a first area included in FIG. 2C and of a second area included in FIG. 2C;

FIG. 2E illustrates other example areas that may be depicted by digital images associated with the camera being positioned as indicated in FIG. 2B;

FIG. 2F illustrates example overlapping areas of a first area included in FIG. 2E and of a second area included in FIG. 2E;

FIG. 2G illustrates example locations and corresponding fields-of-view of a camera with respect to the digital images of FIG. 2A;

FIG. 2H illustrates example rotational positions and corresponding fields-of-view of a camera with respect to the digital images of FIG. 2A; and

FIG. 2I illustrates example overlapping areas of a first area and of a second area that may be depicted by digital images associated with the camera being position as indicated in FIGS. 2G or 2H;

FIG. 2J illustrates other example overlapping areas of a first area and of a second area that may be depicted by digital images associated with the camera being position as indicated in FIGS. 2G or 2H;

FIG. 2K illustrates an example first area that may be depicted by a first digital image at a tilted aerial view of a setting and an example second area that may be depicted by a second digital image at the tilted aerial view with a substantially same tilt angle;

FIG. 2L illustrates example overlapping areas of the first area and the second area of FIG. 2K;

FIG. 2M illustrates an example stereoscopic image;

FIG. 3 illustrates an example computing system, all arranged in accordance with at least some embodiments described in the present disclosure; and

FIG. 4 is a flow-chart of an example computer-implemented method of generating stereoscopic images.

### SUMMARY

According to an aspect of an embodiment, a method may include obtaining a first digital image that depicts a first aerial view of a first area of a setting. The first digital image may have a first center point that corresponds to a first coordinate within the setting. The method may additionally include obtaining a second digital image that depicts a second aerial view of a second area of the setting. The second digital image may have a second center point that corresponds to a second coordinate within the setting. The second coordinate may be laterally offset from the first coordinate by a target offset. Further, the method may include determining an overlapping area where the first area and the second area overlap and obtaining a third digital image based on the overlapping area, the first digital image, and the second digital image. In addition, the method may include generating a first-eye image of a stereoscopic image of the setting based on the first digital image and generating a second-eye image of the stereoscopic image based on the third-digital image. The method may also include presenting the stereoscopic image on a screen of an electronic device.

The objects and advantages of the embodiments will be realized and achieved at least by the elements, features, and combinations particularly pointed out in the claims. Both the foregoing general description and the following detailed description are given as examples and are explanatory and are not restrictive of the invention, as claimed.

### DESCRIPTION OF EMBODIMENTS

Aerial view images are often taken of settings and may be used for many different applications. For example, many people use digital mapping applications (“mapping applications”) to help familiarize themselves with an area or to navigate from one point to another. These mapping applications may be included in or accessible via various devices or navigation systems such as desktop computers, smartphones, tablet computers, automobile navigation systems, Global Positioning System (GPS) navigation devices, etc. In some instances these applications may use aerial view images of a setting. Examples of mapping applications include Google Maps®, Google Earth®, Bing Maps®, etc. Other uses for aerial view images may include analysis of the landscape and geography of planets and viewing of different areas for recreational or other purposes, etc.

In addition, humans have a binocular vision system that uses two eyes spaced approximately two and a half inches (approximately 6.5 centimeters) apart. Each eye sees the world from a slightly different perspective. The brain uses the difference in these perspectives to calculate or gauge distance. This binocular vision system is partly responsible for the ability to determine with relatively good accuracy the distance of an object. The relative distance of multiple objects in a field-of-view may also be determined with the help of binocular vision.

Three-dimensional (stereoscopic) imaging takes advantage of the depth perceived by binocular vision by presenting two images to a viewer where one image is presented to one eye (e.g., the left eye) and the other image is presented to the other eye (e.g., the right eye). The images presented to the two eyes may include substantially the same elements, but the elements in the two images may be offset from each other to mimic the offsetting perspective that may be perceived by the viewer's eyes in everyday life. Therefore, the viewer may perceive depth in the elements depicted by the images.

According to one or more embodiments of the present disclosure, one or more stereoscopic images may be generated based on monoscopic digital images. In some embodiments, the monoscopic digital images may be obtained from a mapping application. The stereoscopic images may each include a first-eye image and a second-eye image that, when viewed using any suitable stereoscopic viewing technique, may result in a user experiencing a three-dimensional effect with respect to the elements included in the stereoscopic images. The monoscopic images may depict an aerial view of geographic setting of a particular geographic location and the resulting stereoscopic images may provide a three-dimensional (3D) rendering of the geographic setting. The presentation of the stereoscopic images to provide a 3D rendering of geographic settings may help users be better familiarized with the geographic settings. Reference to a “stereoscopic image” in the present disclosure may refer to any configuration of a first-eye image and a second-eye image that when viewed by their respective eyes may generate a 3D effect as perceived by a viewer.

In some embodiments, the stereoscopic images may be generated based on the movement of an object (e.g., a vehicle) through the setting in which the first-eye image for each stereoscopic image may include the object at a first particular location in the setting. Additionally, as described below, the second-eye image for each stereoscopic image may represent the setting offset from the representation of the setting in the corresponding first-eye image in which the offset may be based on as if another object that is not actually present (“virtual object”) were next to the object in the first-eye image at a second particular location that may be laterally offset from the first particular location and where the virtual object is facing substantially the same direction as the object. The second-eye images may thus be generated based on as if the virtual object were travelling parallel to the object actually travelling through the setting.

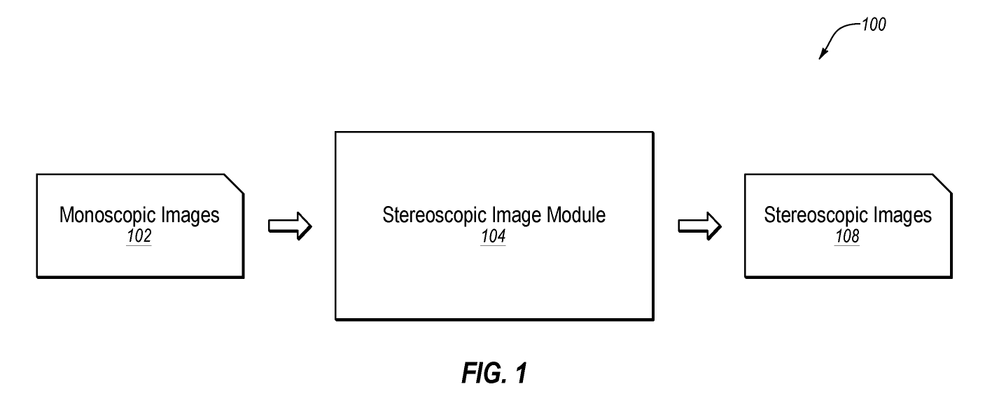

FIG. 1 illustrates an example system 100 configured to generate stereoscopic (3D) images, according to some embodiments of the present disclosure. The system 100 may include a stereoscopic image generation module 104 (referred to hereinafter as “stereoscopic image module 104”) configured to generate one or more stereoscopic images 108. The stereoscopic image module 104 may include any suitable system, apparatus, or device configured to receive monoscopic images 102 and to generate each of the stereoscopic images 108 based on two or more of the monoscopic images 102. For example, in some embodiments, the stereoscopic image module 104 may include software that includes computer-executable instructions configured to cause a processor to perform operations for generating the stereoscopic images 108 based on the monoscopic images 102.

In some embodiments, the monoscopic images 102 may include digital images that depict an aerial view of a geographic setting. For example, the monoscopic images 102 may include digital images captured by aircraft, satellites, telescopes, etc., that depict an aerial view of a geographic setting. In some instances, one or more of the monoscopic images 102 may depict the aerial view from a straight top-to-bottom perspective that may be looking straight down or substantially straight down at the geographic setting. In these or other instances, one or more of the monoscopic images 102 may or may depict the aerial view from a tilted perspective that may not be looking straight down at the geographic setting.

In some embodiments, the stereoscopic image module 104 may be configured to acquire the monoscopic images 102 via a mapping application or another suitable source. For example, in some embodiments, the stereoscopic image module 104 may be configured to access the mapping application via any suitable network such as the Internet to request the monoscopic images 102 from the mapping application. In these or other embodiments, the mapping application and associated monoscopic images 102 may be stored on a same device that may include the stereoscopic image module 104. In these or other embodiments, the stereoscopic image module 104 may be configured to access the mapping application stored on the device to request the monoscopic images 102 from a storage area of the device on which they may be stored.

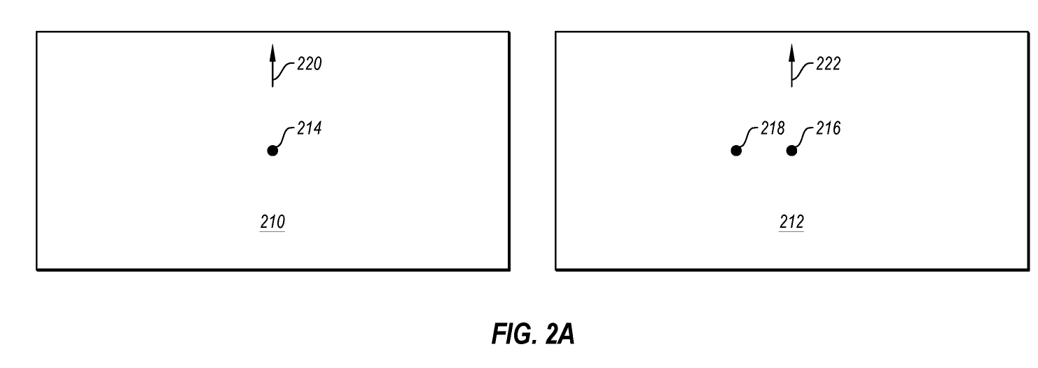

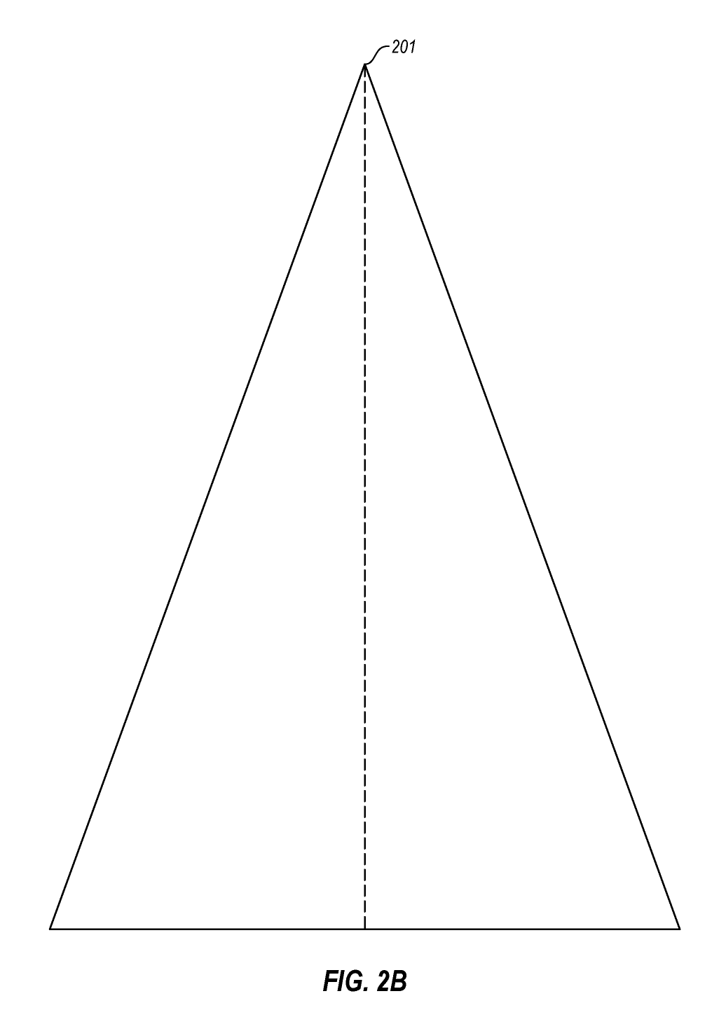

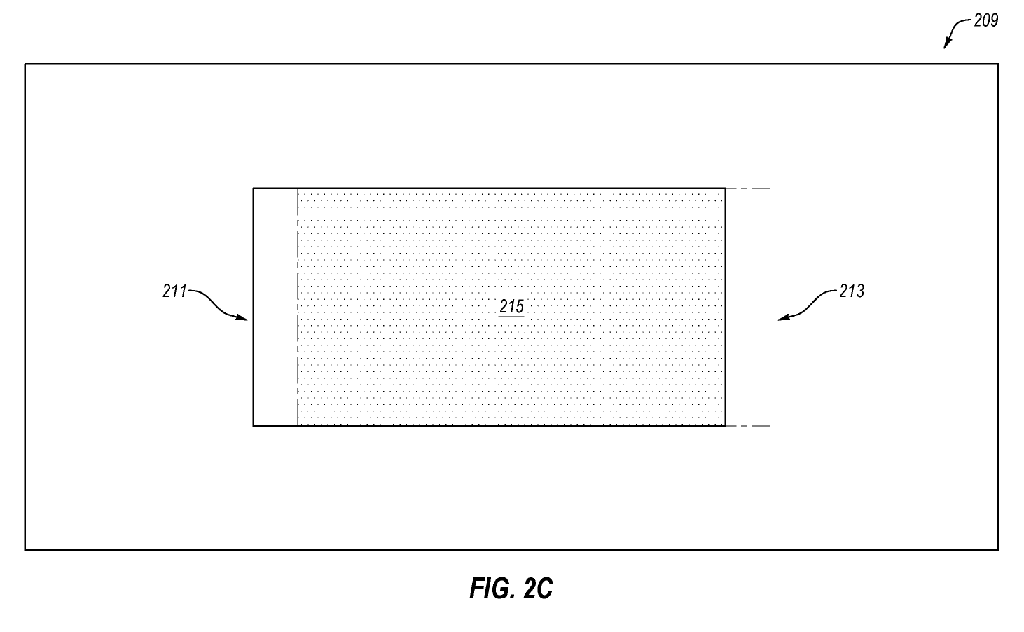

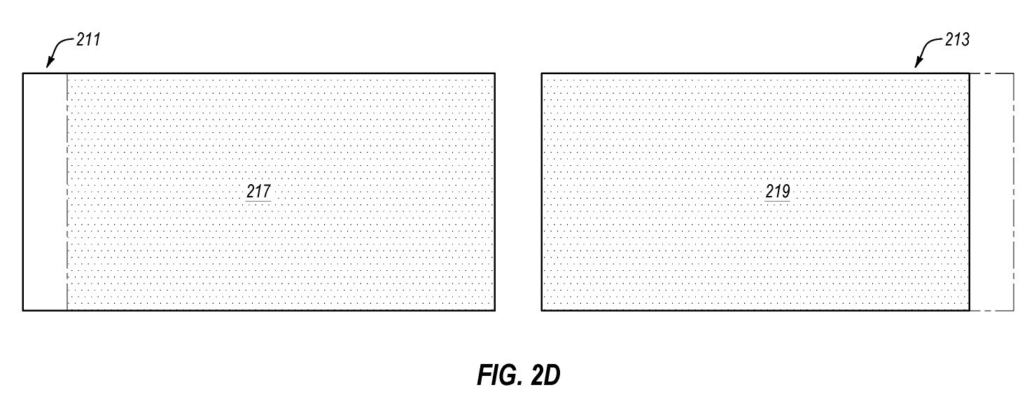

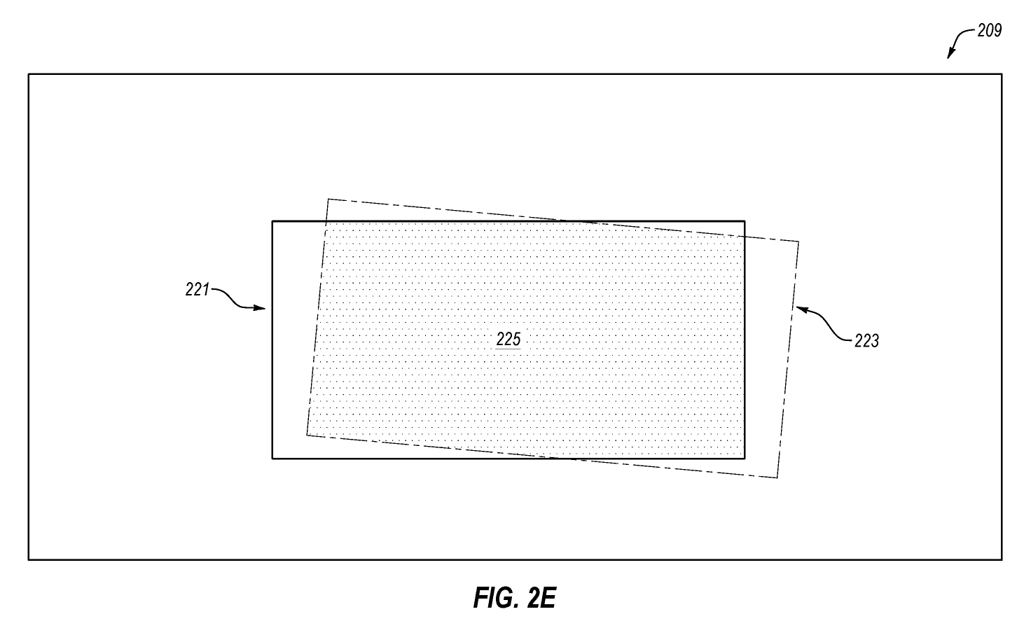

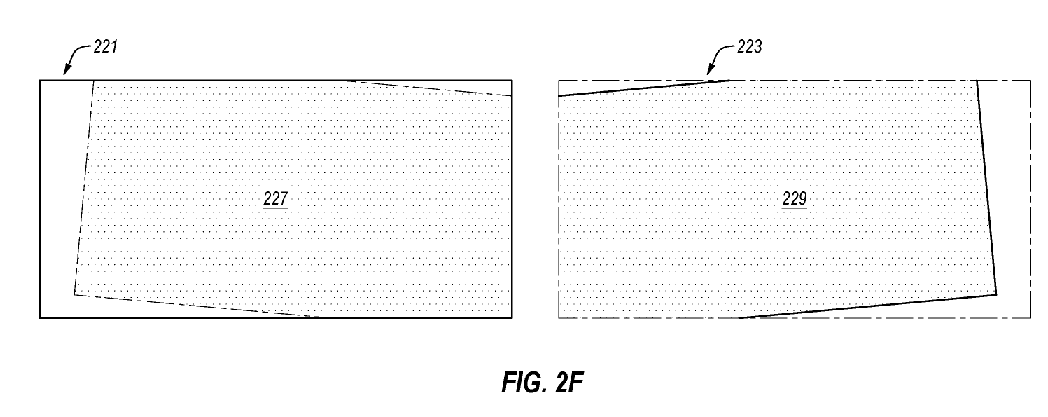

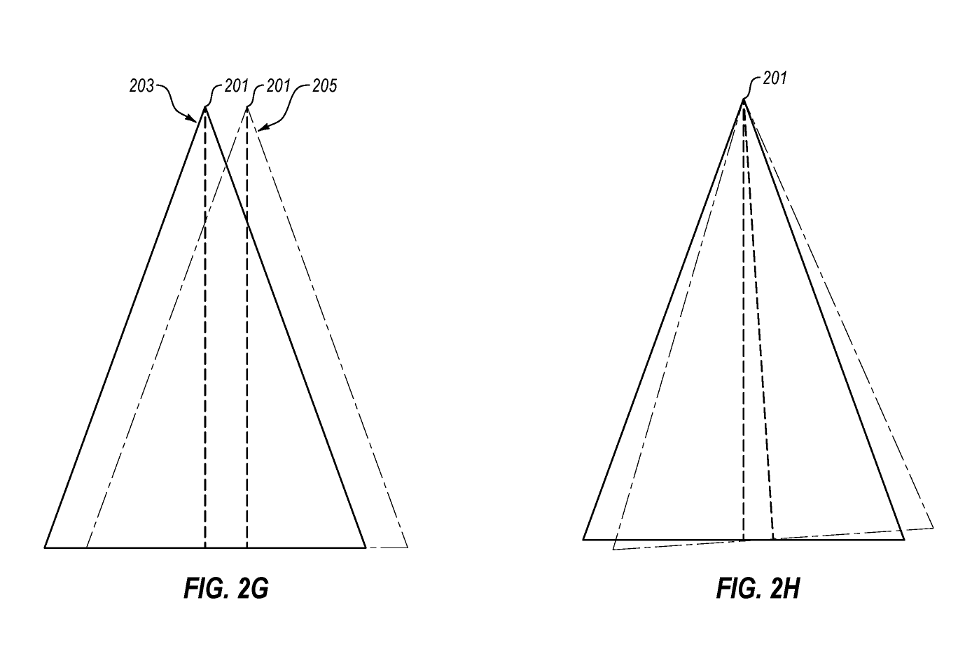

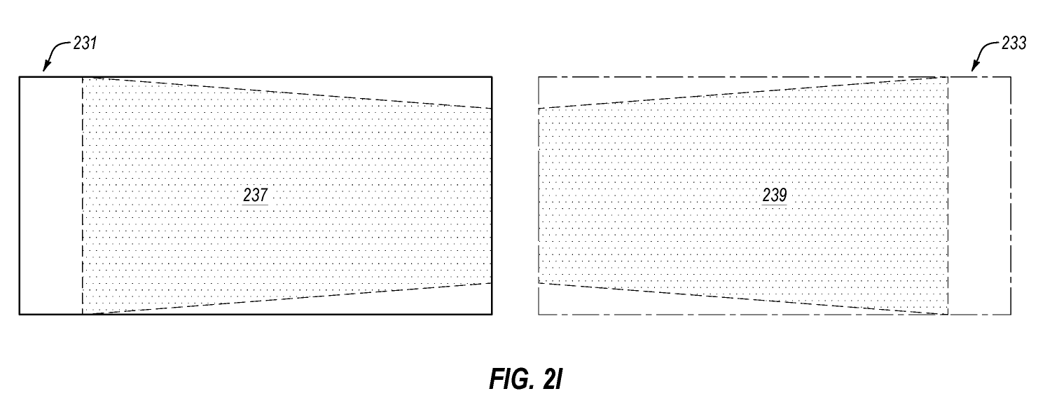

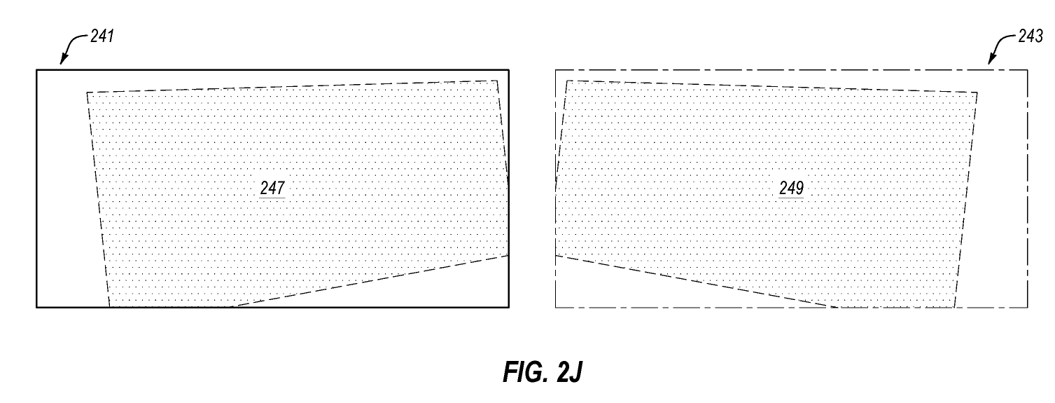

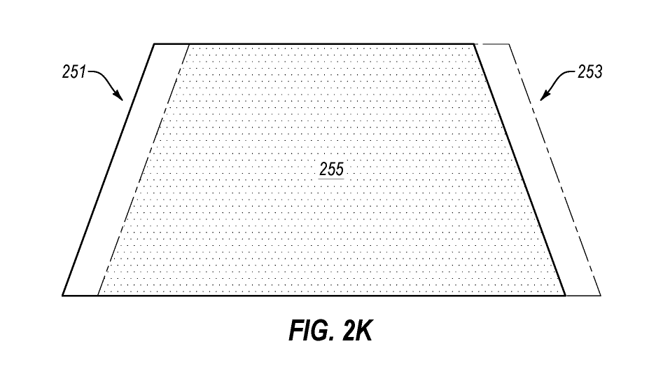

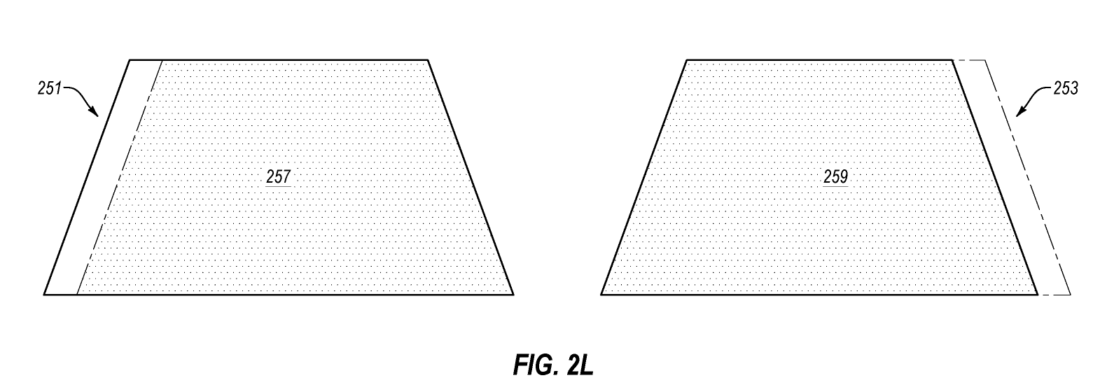

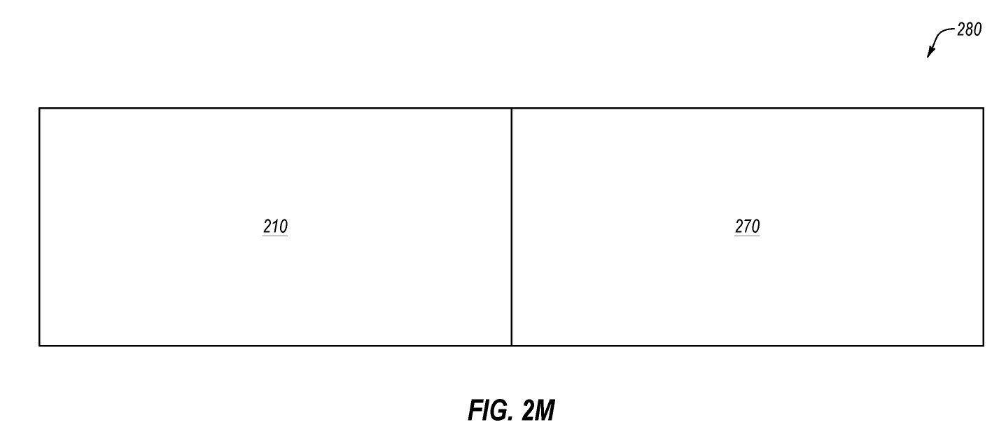

Additionally or alternatively, the stereoscopic image module 104 may be included with the mapping application in which the stereoscopic image module 104 may obtain the monoscopic images 102 via the mapping application by accessing portions of the mapping application that control obtaining the monoscopic images 102. In other embodiments, the stereoscopic image module 104 may be separate from the mapping application, but may be configured to interface with the mapping application to obtain the monoscopic images 102. Additionally or alternatively, the stereoscopic image module 104 may be integrated or used with any other application that may use aerial view images. The stereoscopic image module 104 may be configured to generate one or more stereoscopic images 108 as indicated below with respect to FIGS. 2A-2M.

The stereoscopic image module 104 may be configured to generate any number of stereoscopic images 108 based on any number of monoscopic images 102 using the principles described below. Additionally, as indicated above, because the monoscopic images 102 and the stereoscopic images 108 may be aerial-view images of a setting, the stereoscopic images 108 may be stereoscopic aerial-view images that may be rendered with respect to the setting. Additionally or alternatively, in some embodiments, the stereoscopic image module 104 may be configured to generate a series of stereoscopic images 108 that may correspond to a navigation route such that the navigation route may be rendered in 3D.

In these or other embodiments, the stereoscopic image module 104 may be configured to interface with a display module of a device such that the stereoscopic images 108 may be presented on a corresponding display to render the 3D effect. The stereoscopic image module 104 may be configured to present the stereoscopic images 108 according to the particular requirements of the corresponding display and display module.

Therefore, the stereoscopic image module 104 may be configured to generate stereoscopic aerial-view images based on monoscopic digital images as described above. Modifications, additions, or omissions may be made to FIG. 1 without departing from the scope of the present disclosure.

FIGS. 2A-2M are used to illustrate concepts involved in generating a stereoscopic image 280 (illustrated in FIG. 2M) based on an example first digital image 210 and an example second digital image 212. The stereoscopic image 280 may be an example of one of the stereoscopic images 108 of FIG. 1. Additionally, the first digital image 210 and the second digital image 212 may be examples of monoscopic images that may be included with the monoscopic images 102 of FIG. 1.

In some embodiments, the first digital image 210 may depict a first area of a geographic setting based on one or more properties of a camera that may capture the first digital image 210. For example, the first area may be based on a position of the corresponding camera, a field-of-view of the camera, a zooming factor of the camera, etc.

In some embodiments, the first digital image 210 may depict the first area of the setting according to a first orientation. In particular, in some embodiments, the first orientation may correspond to a navigational direction (e.g., North, South, East, West, Northwest, Northeast, Southwest, Southeast, etc.) that may be used to orient the perspective illustrated in the first area. For example, a first arrow 220 illustrated in FIG. 2A may indicate the navigational direction that may correspond to the top of the first digital image 210 and that may correspond to the first orientation. The first arrow 220 is used merely for explanatory purposes and may not actually be included in the first digital image 210.

In these or other embodiments, the first digital image 210 may be obtained based on a location of an object in the setting. For example, the object may include a vehicle of a user, an electronic device of the user, etc., that may be configured to receive GPS coordinates of the object. The first digital image 210 may be obtained based on the GPS coordinates such that a first coordinate within the setting that may correspond to a first center point 214 of the first digital image 210 may be based on or may be the GPS coordinates of the object.

In these or other embodiments, the first digital image 210 may be obtained based on a particular direction that may be associated with a navigation route included in the first area such that the first orientation may be based on the particular direction. For example, the first digital image 210 may be obtained such that the first orientation corresponds to the particular direction of the navigation route at a coordinate that may correspond to the first center point 214 of the first digital image 210.

Additionally or alternatively, in some embodiments, the first digital image 210 may be obtained based on a direction of travel of the object. For example, in some embodiments, the first digital image 210 may be obtained such that the first orientation may be based on the direction of travel of the object. In particular, in some embodiments, the first digital image 210 may be obtained such that the navigational direction of the first arrow 220 may correspond to—e.g., be based on, be substantially equal to or equal to, etc.—the direction of travel of the object.

Additionally, the second digital image 212 may depict a second area of the geographic setting based on one or more properties of a camera that may capture the second digital image 212. For example, the second area may be based on a position of the corresponding camera, a field-of-view of the camera, a zooming factor of the camera, etc. Further, in some embodiments, the first digital image 210 and the second digital image 212 may be substantially the same size and may have substantially the same aspect ratio in which they may both include the same number of or approximately the same number of pixels in both the horizontal and vertical directions.

In some embodiments, the second digital image 212 may depict the second area of the setting according to a second orientation. In particular, in some embodiments, the second orientation, like the first orientation, may correspond to a navigational direction (e.g., North, South, East, West, Northwest, Northeast, Southwest, Southeast, etc.) that may be used to orient the perspective illustrated in the second area. For example, a second arrow 222 illustrated in FIG. 2A may indicate the navigational direction that may correspond to the top of the second digital image 212 and that may correspond to the second orientation. The second arrow 222 is used merely for explanatory purposes and may not actually be included in the second digital image 212. As indicated below, in some embodiments, the first orientation and the second orientation may be substantially parallel to each other such that the first arrow 220 and the second arrow 222 may indicate substantially the same or the same direction. In other embodiments, the first orientation and the second orientation may be rotated with respect to each other as described in further detail below.

In some embodiments, the first digital image 210 and the second digital image 212 may be such that the first area and the second area may not be the same but may overlap with each other. In these or other embodiments, the first digital image 210 and the second digital image 212 may be such that one or more elements of the overlapping area of the first digital image 210 and the second digital image 212 may be laterally offset from each other. Additionally or alternatively, the lateral offset of the one or more elements may be based on a target lateral offset. The target lateral offset may be based on a target distance between same elements of the first digital image 210 and the second digital image 212 that when the stereoscopic image 280 is viewed, a 3D effect may be perceived with respect to the corresponding elements. In these or other embodiments, the target offset may thus be based on a target degree of 3D effect.

By way of example, the first digital image 210 may include the first center point 214 and the second digital image 212 may include a second center point 216. The first center point 214 may correspond to the first coordinate of the setting and the second center point 216 may correspond to a second coordinate of the setting that may be different from the first coordinate of the setting. In some embodiments, the second coordinate of the setting may be laterally offset from the first coordinate of the setting. In some embodiments, the “lateral” nature of the lateral offset of the first coordinate with respect to the second coordinate may be with respect to the first orientation and not the second orientation in instances in which the first and second orientations are rotated with respect to each other and not parallel to each other. Additionally the second digital image 212 may include a second offset point 218. The second offset point 218 may be laterally offset from the second center point 216. Additionally, the second offset point 218 may be laterally offset from the second center point 216 by a target offset that may be based on a target degree of a 3D effect. Reference of a lateral offset with respect to a particular orientation between first and second coordinates may indicate that the first coordinate depicted in a digital image with the particular orientation may be horizontally removed in the digital image from the second coordinate with little to no vertical offset in the digital image between the first coordinate and the second coordinate.

Due to the lateral offset, the first coordinate may be depicted in the second digital image 212 but may correspond to the second offset point 218 and not the second center point 216. As such, the first coordinate may be depicted by the first digital image 210 and the second digital image 212 but may not be depicted at the same locations in the first digital image 210 and the second digital image 212. Further, the first coordinate may thus be laterally offset in the first digital image 210 as compared to the second digital image 212 by the target offset.

In some embodiments, the second digital image 212 may be obtained based on the first digital image 210 and the target offset. For example, in some embodiments the second digital image 212 may be requested based on coordinates that may be associated with the first area such that one or more of the coordinates may also be included in the second area but offset by the target offset in the second digital image 212 as compared to their locations in the first digital image 210. In particular, in some embodiments, the second digital image 212 may be obtained based on the first coordinate that may correspond to the first center point 214 and the target offset such that the first coordinate may be offset from the second center point 216 by the target offset and may thus accordingly correspond to the second offset point 218.

In these or other embodiments, the second digital image 212 may be obtained based on a target direction of the target offset. For example, in the illustrated example, the target direction may be to the right such that the second area may be offset to the right as compared to the first area and such that the second offset point 218 that corresponds to the first coordinate may be to the left of the second center point 216. In these or other embodiments, the target direction may be to the left. Additionally or alternatively, in some embodiments, the target direction may be based on whether the first digital image 210 corresponds to the left-eye and the second digital image 212 corresponds to the right-eye or vice versa.

Additionally or alternatively, in some embodiments, the second digital image 212 may be obtained based on the first orientation associated with the first digital image 210. For example, in some embodiments, the second digital image 212 may be obtained based on the first orientation such that the second orientation is substantially parallel to or parallel to the first orientation. In particular, in some embodiments, the second digital image 212 may be obtained such that the navigational direction that may be indicated by the second arrow 222 may be the same as or substantially the same as the navigational direction that may be indicated by the first arrow 220.

As another example, in some embodiments, the second digital image 212 may be obtained based on the first orientation such that the second orientation is rotated with respect to the first orientation. In these or other embodiments, the rotation may have a rotational direction that may be toward the first orientation. For example, the first orientation may correspond to the first arrow 220 pointing substantially north. Additionally, the second digital image 212 may be based on a shift to the right from the first digital image 210. The second orientation in this instance may be such that the second arrow 222 is pointing at least slightly northwest such that the rotational direction of the second orientation may be based on the first orientation. As another example, the first orientation may again correspond to the first arrow 220 pointing substantially north. Additionally, the second digital image 212 may be based on a shift to the left from the first digital image 210. The second orientation in this instance may be such that the second arrow 222 is pointing at least slightly northeast such that the rotational direction of the second orientation may be based on the first orientation. In these or other embodiments, the first orientation may be rotated instead of or in addition to such that the first orientation and the second orientation may be rotated toward each other.

In some embodiments, the amount of rotation of the first orientation and the second orientation toward each other may be based on a target rotation angle. The target rotation angle may be based on a target 3D effect in some embodiments. Additionally or alternatively, the target rotation angle may be based on a target focal point for the target 3D effect.

Additionally or alternatively, in some embodiments, the second digital image 212 may be obtained based on the location of the object in the setting and a direction of travel of the object in the setting. For example, as indicated above, in some embodiments, the first digital image 210 may be obtained based on the location of the object and the direction of travel of the object in that the first digital image 210 may be centered based on the location of the object and in that the first digital image 210 may have an orientation that is based on the direction of travel of the object. In these and other embodiments, the second digital image 212 may be obtained based on a virtual object that may be travelling parallel to the object.

For example, a virtual location of the virtual object may be obtained based on the location of the object in the setting, the target offset, and the direction of travel of the object. In particular, the virtual location may be laterally offset from the location of the object by the target offset. Additionally, the lateral offset may be with respect to the first orientation of the first digital image 210, which may be based on the direction of travel of the object. As such, the virtual location may be parallel to the location of the object. In these or other embodiments, the second digital image 212 may be obtained based on the virtual location such that the second coordinate, which may correspond to the second center point 216, may correspond to the virtual location of the virtual object. Further, the second orientation of the second digital image 212 may based on the first orientation of the first digital image 210, such as discussed above. As indicated above, the first orientation may be based on the direction of travel of the object and the second orientation may be based on the first orientation to mimic the virtual object travelling parallel to the object. Additionally or alternatively, in some embodiments, a virtual direction of travel of the virtual object may be obtained based on the direction of travel of the object such that the direction of travel of the virtual object may be substantially parallel to the direction of travel of the object and the second orientation may be obtained based on the virtual direction of travel. As such, the second digital image 212 may be obtained based on a virtual object travelling parallel to the object in some embodiments.

In some embodiments, the stereoscopic image 280 may be generated based on the overlapping area of the first digital image 210 and the second digital image 212. For example, in some embodiments, the overlapping area that is included in the first area of the setting associated with the first digital image 210 and the second digital image 212 may be determined. Based on the overlapping area, a first sub-area of the first area may be determined. The first sub-area may include a portion of the first area that is included in the overlapping area. In some embodiments, the first sub-area may include all of or substantially all of the portion of the first area that is included in the overlapping area. Similarly, based on the overlapping area, a second sub-area of the second area may be determined. The second sub-area may include a portion of the second area that is included in the overlapping area. In some embodiments, the second sub-area may include all of or substantially all of the portion of the second area that is included in the overlapping area.

The overlapping area and the resulting first sub-area and second sub-area may be based on a variety of factors such as camera locations during capture of the first digital image 210 and the second digital image 212, camera rotation during capture of the first digital image 210 and the second digital image 212, the first and second orientations with respect to each other, an amount of offset between the first area and the second area, and an amount of tilt in the aerial views of the first digital image 210 and the second digital image 212, a zoom factor of the first digital image 210, a zoom factor of the second digital image 212, a size of the first digital image 210, a size of the second digital image 212, a size of the first area, and a size of the second area.

Below are some examples of how the overlapping area may differ based on one or more factors listed above. In the examples given below, the sizes of the first digital image 210 and the second digital image 212, the sizes of the first area and the second area, and the tilt angles and zoom factors associated with the first digital image 210 and the second digital image 212 may be substantially the same. The examples listed below are given to aid understanding and are not all inclusive and do not cover every scenario.

In some embodiments, the first digital image 210 and the second digital image 212 may be portions of a digital image that may be captured by a camera at a particular position. For example, FIG. 2B illustrates a camera 201 that may be configured to capture a particular digital image. In some embodiments, the camera 201 may be positioned above a setting such that the camera 201 may capture an aerial view of the setting. As such, the particular digital image may depict an aerial view of the setting. For example, FIG. 2B illustrates a side-view of an example field of view and positioning of the camera 201 with respect to capture of the particular digital image.

The first digital image 210 and the second digital image 212 may be portions of the particular digital image that may be captured by the camera 201 such that the first area depicted by the first digital image 210 and the second area depicted by the second digital image 212 may each be included in a larger area that may be depicted by the particular digital image.

For example, FIG. 2C illustrates an area 209 that may be depicted by the particular digital image, a first area 211 that may be depicted by the first digital image 210, and a second area 213 that may be depicted by the second digital image 212. The first area 211 and the second area 213 may overlap over an overlapping area 215 that may include a first sub-area of the first area 211 and a second sub-area of the second area 213. FIG. 2D illustrates an example of a first sub-area 217 with respect to the first area 211 and an example of a second sub-area 219 with respect to the second area 213. The first sub-area 217 may be the portion of the first area 211 that may be included in the overlapping area 215 and the second sub-area 219 may be the portion of the second area 213 that may be included in the overlapping area 215. The size of the overlapping area 215 and consequently of the first sub-area 217 and of the second sub-area 219 as compared to the size of the first area 211 and the size of the second area 213 may be based on the amount of offset that may be between the first area 211 and the second area 213.

In the illustrated example of FIGS. 2C and 2D, the first area 211 and the second area 213 may be substantially the same size and the first orientation associated with the first area 211 may be substantially the same as the second orientation associated with the second area 213 such that the size and location of the overlapping area 215 may be based mainly on the amount of offset between the first area 211 and the second area 213.

As mentioned above, in some embodiments, the second orientation may be rotated with respect to the first orientation and the rotation may also affect the overlapping area. For example, FIG. 2E illustrates the area 209, a first area 221 that may be depicted by the first digital image 210, and a second area 223 that may be depicted by the second digital image 212. The first area 221 and the second area 223 may have orientations that may be rotated with respect to each other. The first area 221 and the second area 223 may accordingly overlap over an overlapping area 225 that may include a first sub-area of the first area 221 and a second sub-area of the second area 223. FIG. 2F illustrates an example of a first sub-area 227 with respect to the first area 221 and an example of a second sub-area 229 with respect to the second area 223. The first sub-area 227 may be the portion of the first area 221 that may be included in the overlapping area 225 and the second sub-area 229 may be the portion of the second area 223 that may be included in the overlapping area 225. The size of the overlapping area 215 and consequently of the first sub-area 217 and of the second sub-area 219 as compared to the size of the first area 221 and the size of the second area 223 may be based on the amount of offset that may be between the first area 221 and the second area 223. In addition, the size and the shape of the overlapping area 225, the first sub-area 227, and the second sub-area 229 may be based on the rotation angle that may be between the first orientation and the second orientation.

As another example, in some embodiments, the first digital image 210 and the second digital image 212 may be captured with a camera at different locations or different rotation angles, which may also affect the size, shape, etc. of the overlapping area. For example, FIG. 2G illustrates an example in which the camera 201 may capture the first digital image 210 at a first location 203 and in which the camera 201 may capture the second digital image 212 at a second location 205. FIG. 2G illustrates a side-view of the camera 201 and its field of view at the first location 203 and at the second location 205. In some embodiments, the distance between the first location 203 and the second location 205 may relate to the lateral offset between the first area and the second area in some embodiments.

As another example, FIG. 2H illustrates an example in which the camera 201 may capture the first digital image 210 at a first rotational position and in which the camera 201 may capture the second digital image 212 at a second rotational position. The solid line triangle of FIG. 2H may correspond to the field of view of the camera 201 at the first rotational position and the dash-dot line triangle of FIG. 2H may correspond to the second rotational position. The amount of rotation between the first rotational position and the second rotational position may also affect the lateral offset between the first area and the second area.

The capture of the first digital image 210 and the second digital image 212 according to FIG. 2G or 2H may cause not only the first area and the second area to include different sized portions of the setting, but the perspectives of the setting may also differ due to the different camera angles. The different perspectives may also affect the shape and size of the overlapping area.

For example, FIG. 2I illustrates a first area 231 that may be depicted by the first digital image 210 when the first digital image 210 is captured with the camera 201 at the first location 203 referred to with respect to FIG. 2G or is at the first rotational position referred to with respect to FIG. 2H. FIG. 2I illustrates a second area 233 that may be depicted by the second digital image 212 when the second digital image 212 is captured with the camera 201 at the second location 205 referred to with respect to FIG. 2G or at the second rotational position referred to with respect to FIG. 2H.

FIG. 2I also illustrates an example of a first sub-area 237 with respect to the first area 231 and an example of a second sub-area 239 with respect to the second area 233. The first sub-area 237 may be the portion of the first area 231 that may be included in the overlapping area between the first area 231 and the second area 233. In addition, the second sub-area 239 may be the portion of the second area 233 that may be included in the overlapping area. The size and shape of the overlapping area and the corresponding first sub-area 237 and the second sub-area 239 may be based on the difference in the first location 203 and the second location 205 or the difference in the first rotational position and the second rotational position. For example, the trapezoidal dimensions of the first sub-area 237 and the second sub-area 239 may indicate different distances that may be represented by the first digital image 210 and the second digital image 212 and may vary based on the differences. Additionally, the trapezoidal dimensions may differ depending on whether a change in location of the camera 201 has occurred—such as indicated in FIG. 2G—or a change in rotational position of the camera 201 has occurred—such as indicated in FIG. 2H.

In these or other embodiments, the second orientation may be rotated with respect to the first orientation, which may also affect the overlapping area in instances in which the camera position (e.g., location or rotational position) differs during the capture of the first digital image 210 and the second digital image 212. FIG. 2J illustrates a first area 241 that may be depicted by the first digital image 210 when the first digital image 210 is captured with the camera 201 at the first location 203 referred to with respect to FIG. 2G or is at the first rotational position referred to with respect to FIG. 2H. FIG. 2J illustrates a second area 243 that may be depicted by the second digital image 212 when the second digital image 212 is captured with the camera 201 at the second location 205 referred to with respect to FIG. 2G or at the second rotational position referred to with respect to FIG. 2H.

FIG. 2J also illustrates an example of a first sub-area 247 with respect to the first area 241 and an example of a second sub-area 249 with respect to the second area 243. The first sub-area 247 may be the portion of the first area 241 that may be included in the overlapping area between the first area 241 and the second area 243. In addition, the second sub-area 249 may be the portion of the second area 243 that may be included in the overlapping area.

The size and shape of the overlapping area and the corresponding first sub-area 247 and the second sub-area 249 may be based on the difference in the first location 203 and the second location 205 or the difference in the first rotational position and the second rotational position. For example, the trapezoidal dimensions of the first sub-area 247 and the second sub-area 249 may vary based on the differences. Additionally, the trapezoidal dimensions may differ depending on whether a change in location of the camera 201 has occurred—such as indicated in FIG. 2G—or a change in rotational position of the camera 201 has occurred—such as indicated in FIG. 2H. Further, the first area 241 and the second area 243 may have orientations that may be rotated with respect to each other, which may affect the sizes and shapes of the first sub-area 247 and the second sub-area 249 such as illustrated in FIG. 2J.

Additionally, an amount of tilt of the aerial views depicted in the first digital image 210 and the second digital image 212 may also affect the size and shape of the overlapping area. For example, FIG. 2K illustrates an example first area 251 that may be depicted by the first digital image 210 at a tilted aerial view of the setting. FIG. 2K also illustrates an example second area 253 that may be depicted by the second digital image 212 at the tilted aerial view with a substantially same tilt angle. As illustrated in FIG. 2K, the first area 251 and the second area 253 may have a trapezoidal shape that may indicate that a greater lateral distance may be represented at the tops of the first digital image 210 and the second digital image 212 than at the bottoms.

The first area 251 and the second area 253 may overlap over an overlapping area 255 that may include a first sub-area of the first area 251 and a second sub-area of the second area 253. FIG. 2L illustrates an example of a first sub-area 257 with respect to the first area 251 and an example of a second sub-area 259 with respect to the second area 253. The first sub-area 257 may be the portion of the first area 251 that may be included in the overlapping area 255 and the second sub-area 259 may be the portion of the second area 253 that may be included in the overlapping area 255. The size of the overlapping area 255 and consequently of the first sub-area 257 and of the second sub-area 259 may vary based on the degree of tilt. Additionally, the trapezoidal dimensions of the first area 251, the second area 253, the overlapping area 255, the first sub-area 257 and the second sub-area 259 may also vary depending on the amount of tilt.

Additionally, in the illustrated example of FIG. 2K, the first digital image 210 and the second digital image 212 may be part of a same particular image that may be captured with the camera 201 at a same location, such as described with respect to FIG. 2B. In other embodiments, the first digital image 210 and the second digital image 212 with tilted aerial views may be captured with the camera 201 at different positions—such as indicated with respect to FIGS. 2G and 2H. In these and other embodiments, the corresponding overlapping area, first sub-area, and second sub-area may have properties of the trapezoidal shapes indicated in FIG. 2I as well as those indicated in FIGS. 2K and 2L. Additionally, in some embodiments, the first digital image 210 and the second digital image 212 with tilted aerial views may also correspond to orientations that may not be parallel to each other, which may also affect the size and shape of the resulting overlapping area, first sub-area, and second sub-area.

The overlapping area between the first digital image 210 and the second digital image 212 (and consequently the corresponding first sub-area and the corresponding second sub-area) may be determined using any suitable technique. For example, in some embodiments it may be determined based on a comparison of image data included in pixels of the first digital image 210 and the second digital image 212 to determine which elements of the setting may be depicted in both the first digital image 210 and the second digital image 212. Additionally or alternatively, the overlapping area may be determined using and based on geometric principles that may be associated with camera locations during capture of the first digital image 210 and the second digital image 212, camera rotation during capture of the first digital image 210 and the second digital image 212, the first and second orientations with respect to each other, an amount of offset between the first area and the second area, and an amount of tilt in the aerial views of the first digital image 210 and the second digital image 212, a zoom factor of the first digital image 210, a zoom factor of the second digital image 212, a size of the first digital image 210, a size of the second digital image 212, a size of the first area, and a size of the second area.

In some embodiments, a third digital image 270 (depicted in FIG. 2M) may be obtained based on the overlapping area, the first digital image 210, and the second digital image 212. For example, in some embodiments, the third digital image 270 may be obtained based on the second sub-area that corresponds to the overlapping area and that is depicted in the second digital image. Further, the third digital image 270 may be obtained based on the size (e.g., resolution), aspect ratio, and dimensions (e.g., number of horizontal and vertical pixels) of the first digital image 210 such that the third digital image 270 may have substantially the same size, aspect ratio, and dimensions.

By way of example, with respect to the example given with respect to FIGS. 2C and 2D, the third digital image 270 may be requested from the mapping application such that it depicts a third area of the setting that is substantially the same as the second sub-area 219. Further, the third digital image 270 may be requested from the mapping application such that it has substantially the same size, aspect ratio, and dimensions as the first digital image 210. In this example, the third digital image 270 may be requested such that a third orientation of the third area may be the same as the second orientation.

By way of another example, with respect to the example given with respect to FIGS. 2E and 2F, the third digital image 270 may be requested from the mapping application such the third area is included in the second sub-area 229. In this example, the third digital image 270 may also be requested such that the third orientation may be the same as the second orientation. In these and other embodiments, the third digital image 270 may be requested from the mapping application such that it has substantially the same size, aspect ratio, and dimensions as the first digital image 210 while maintaining that the third area is completely included in the second sub-area 229. In these and other embodiments, the third digital image 270 may be requested such that the third area may cover as much of the second-sub area 229 as possible while also having the same size, aspect ratio, and dimensions as the first digital image 210 and/or such that the third orientation is still the same as the second orientation.

By way of another example, with respect to the example given with respect to FIG. 2I, the third digital image 270 may be requested from the mapping application such the third area is included in the second sub-area 239. In this example, the third digital image 270 may also be requested such that the third orientation may be the same as the second orientation. In these and other embodiments, the third digital image 270 may be requested from the mapping application such that it has substantially the same size, aspect ratio, and dimensions as the first digital image 210 while maintaining that the third area is completely included in the second sub-area 239. In these and other embodiments, the third digital image 270 may be requested such that the third area may cover as much of the second-sub area 239 as possible while also having the same size, aspect ratio, and dimensions as the first digital image 210 and/or such that the third orientation is still the same as the second orientation.

By way of another example, with respect to the example given with respect to FIG. 2J, the third digital image 270 may be requested from the mapping application such the third area is included in the second sub-area 249. In this example, the third digital image 270 may also be requested such that the third orientation may be the same as the second orientation. In these and other embodiments, the third digital image 270 may be requested from the mapping application such that it has substantially the same size, aspect ratio, and dimensions as the first digital image 210 while maintaining that the third area is completely included in the second sub-area 249. In these and other embodiments, the third digital image 270 may be requested such that the third area may cover as much of the second-sub area 249 as possible while also having the same size, aspect ratio, and dimensions as the first digital image 210 and/or such that the third orientation is still the same as the second orientation.

By way of another example, with respect to the example given with respect to FIGS. 2K and 2L, the third digital image 270 may be requested from the mapping application such the third area is included in the second sub-area 259. In this example, the third digital image 270 may also be requested such that the third orientation may be the same as the second orientation. In these and other embodiments, the third digital image 270 may be requested from the mapping application such that it has substantially the same size, aspect ratio, and dimensions as the first digital image 210 while maintaining that the third area is completely included in the second sub-area 259. In these and other embodiments, the third digital image 270 may be requested such that the third area may cover as much of the second-sub area 259 as possible while also having the same size, aspect ratio, and dimensions as the first digital image 210 and/or such that the third orientation is still the same as the second orientation.

The above examples of obtaining the third digital image 270 are not exhaustive or limiting. For example, as indicated above, the size, shape, dimensions, etc., of the second sub-area may vary depending on many different factors. Accordingly, in general the third digital image 270 may be requested from the mapping application such the third area is included in the second sub-area associated with the second digital image 212 whatever the shape, size, dimensions, etc., of the second sub-area may be in some embodiments. Additionally or alternatively, in general the third digital image 270 may also be requested such that the third orientation may be the same as the second orientation. In these and other embodiments, the third digital image 270 may be requested from the mapping application such that it has substantially the same size, aspect ratio, and dimensions as the first digital image 210 while maintaining that the third area is completely included in the corresponding second sub-area. In these and other embodiments, the third digital image 270 may be requested such that the third area may cover as much of the corresponding second-sub area as possible while also having the same size, aspect ratio, and dimensions as the first digital image 210 and/or such that the third orientation is still the same as the second orientation.

Additionally or alternatively, in some embodiments the third digital image 270 may be obtained by performing a series of cropping operations and resizing operations with respect to the second digital image 212. For example, in some embodiments, the second digital image 212 may be cropped to only depict the second-sub area. In these and other embodiments, the cropped second digital mage may be resized to have the same resolution, aspect ratio, dimensions, etc., as the first digital image 210 to obtain the third digital image 270. Examples of this principle are included in U.S. Provisional Application No. 62/254,404, Entitled “STEREOSCOPIC MAPPING,” which was filed on Nov. 12, 2015 and which is incorporated by reference in the present disclosure in its entirety.

Further, the above description is given with respect to obtaining the third digital image 270 based on the second sub-area associated with the second digital image 212 and the resolution, aspect ratio, dimensions, etc., of the first digital image 210. However, in other embodiments, the third digital image 270 may instead be obtained based on the first sub-area associated with the first digital image 210 and the resolution, aspect ratio, dimensions, etc., of the second digital image 212.

In some embodiments—e.g., when the third digital image 270 is generated based on the second sub-area—the stereoscopic image 280 may include the first digital image 210 and the third digital image 270. In particular, the first digital image 210 may be used as a first-eye image of the stereoscopic image 280 and the third digital image 270 may be used as a second-eye image of the stereoscopic image 280, such as illustrated in FIG. 2M. Additionally or alternatively, in some embodiments—e.g., when the third digital image 270 is generated based on the third sub-area—the stereoscopic image 280 may include the second digital image 212 and the third digital image 270. In particular, the second digital image 212 may be used as a first-eye image of the stereoscopic image 280 and the third digital image 270 may be used as a second-eye image of the stereoscopic image 280.

Therefore, the stereoscopic image 280 may be generated based on aerial view images. Additionally, as indicated above, the aerial view images may be obtained based on the movement of an object or based on a navigation path such that the stereoscopic image 280 may be generated for a navigation application in some embodiments. Further, as indicated above, multiple stereoscopic images may be generated in the manner described with respect to the stereoscopic image 280 as the object moves or is simulated as moving along a path in the setting to render a 3D effect with respect to the movement along the path in the setting. In addition, the second digital image 212 may be obtained based on a virtual object as described above, such that the third digital image 270, and thus the stereoscopic image 280, may be generated based on the virtual object and travel of the virtual object.

Modifications, additions, or omissions may be made with respect to embodiments described above with respect to FIGS. 2A-2M. For example, the relationships between elements depicted may not be to scale and are for illustrative purposes only. In particular, the angles illustrated, the sizes and shapes of the overlapping areas, the degree of overlap, etc., are merely to illustrate the principles described are not limiting and are not necessarily to scale. Additionally, although various operations are described in a particular order, one or more of the operations may be performed in a differing order than described or at the same time.

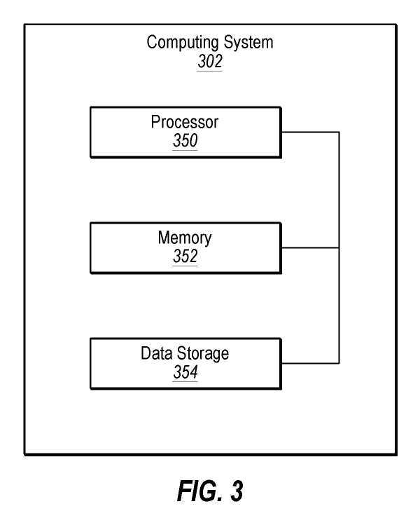

FIG. 3 illustrates a block diagram of an example computing system 302, according to at least one embodiment of the present disclosure. The computing system 302 may be configured to implement one or more operations associated with a stereoscopic image module (e.g., the stereoscopic image module 104). The computing system 302 may include a processor 350, a memory 352, and a data storage 354. The processor 350, the memory 352, and the data storage 354 may be communicatively coupled.

In general, the processor 350 may include any suitable special-purpose or general-purpose computer, computing entity, or processing device including various computer hardware or software modules and may be configured to execute instructions stored on any applicable computer-readable storage media. For example, the processor 350 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in Figure. 3, the processor 350 may include any number of processors configured to, individually or collectively, perform or direct performance of any number of operations described in the present disclosure. Additionally, one or more of the processors may be present on one or more different electronic devices, such as different servers.

In some embodiments, the processor 350 may interpret and/or execute program instructions and/or process data stored in the memory 352, the data storage 354, or the memory 352 and the data storage 354. In some embodiments, the processor 350 may fetch program instructions from the data storage 354 and load the program instructions in the memory 352. After the program instructions are loaded into memory 352, the processor 350 may execute the program instructions.

For example, in some embodiments, the sim module may be included in the data storage 354 as program instructions. The processor 350 may fetch the program instructions of the sim module from the data storage 354 and may load the program instructions of the sim module in the memory 352. After the program instructions of the sim module are loaded into memory 352, the processor 350 may execute the program instructions such that the computing system may implement the operations associated with the sim module as directed by the instructions.

The memory 352 and the data storage 354 may include computer-readable storage media for carrying or having computer-executable instructions or data structures stored thereon. Such computer-readable storage media may include any available media that may be accessed by a general-purpose or special-purpose computer, such as the processor 350. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 350 to perform a certain operation or group of operations.

Modifications, additions, or omissions may be made to the computing system 302 without departing from the scope of the present disclosure. For example, in some embodiments, the computing system 302 may include any number of other components that may not be explicitly illustrated or described.

As indicated above, the embodiments described in the present disclosure may include the use of a special purpose or general purpose computer (e.g., the processor 350 of FIG. 3) including various computer hardware or software modules, as discussed in greater detail below. Further, as indicated above, embodiments described in the present disclosure may be implemented using computer-readable media (e.g., the memory 352 of FIG. 3) for carrying or having computer-executable instructions or data structures stored thereon.

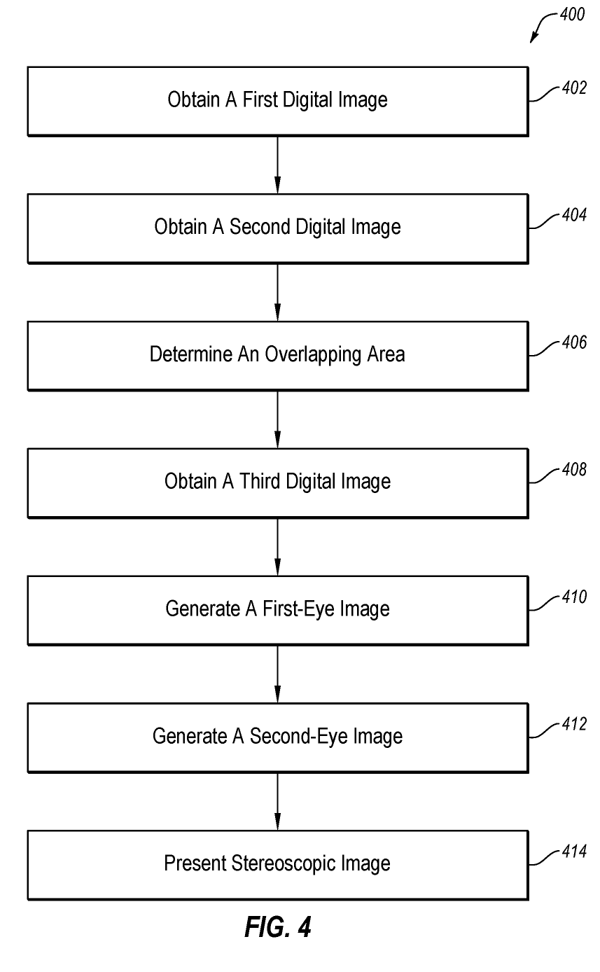

FIG. 4 is a flow-chart of an example computer-implemented method 400 of generating stereoscopic images, according to one or more embodiments of the present disclosure. The method 400 may be implemented, in some embodiments, by the stereoscopic image module 104 of FIG. 1. In these or other embodiments, the method 400 may be implemented by one or more components of a system that may include a stereoscopic image module, such as the computing system 302 of FIG. 3. Although illustrated as discrete blocks, various blocks may be divided into additional blocks, combined into fewer blocks, or eliminated, depending on the desired implementation.

The method 400 may begin at block 402 where a first digital image may be obtained. The first digital image may depict a first aerial view of a first area of a setting. The first digital image may have a first center point that may correspond to a first coordinate within the setting. The first digital image 210 described above is an example of the first digital image that may be obtained. Further, in some embodiments, the first digital image may be obtained in any manner such as described above with respect to obtaining the first digital image 210.

At block 404 a second digital image may be obtained based on the first digital image and based on a target offset. The second digital image may depict a second aerial view of a second area of the setting. The second digital image may have a second center point that may correspond to a second coordinate within the setting. The second coordinate may be laterally offset from the first coordinate by the target offset. In some embodiments, the lateral offset of the second coordinate from the first coordinate may be with respect to a first orientation of the first digital image. The second digital image 212 described above is an example of the second digital image that may be obtained. Further, in some embodiments, the second digital image may be obtained in any manner such as described above with respect to obtaining the second digital image 212.

At block 406, an overlapping area where the first area and the second area overlap may be determined. Examples of the overlapping area are given above with respect to one or more of FIGS. 2A-2M. Additionally, the overlapping area may be determined in any suitable manner such as described above.

At block 408, a third digital image may be obtained based on the overlapping area, the first digital image, and the second digital image. The third digital image 270 described above is an example of the third digital image that may be obtained. Further, in some embodiments, the third digital image may be obtained in any manner such as described above with respect to obtaining the third digital image 270.

At block 410, a first-eye image of a stereoscopic image of the setting may be generated based on the first-digital image. At block 412, a second-eye image of the stereoscopic image may be generated based on the third digital image. In some embodiments, the first and second eye images may be generated as described above with respect to one or more of FIGS. 2A-2M. At block 414, the stereoscopic image may be presented on a screen using any suitable technique.

Therefore, the method 400 may be used to generate a stereoscopic image according to one or more embodiments of the present disclosure. Modifications, additions, or omissions may be made to the method 400 without departing from the scope of the present disclosure. For example, the functions and/or operations described with respect to FIG. 4 may be implemented in differing order without departing from the scope of the present disclosure. Furthermore, the outlined functions and operations are only provided as examples, and some of the functions and operations may be optional, combined into fewer functions and operations, or expanded into additional functions and operations without detracting from the essence of the disclosed embodiments.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

In addition, in the appended claims, the term “non-transitory computer-readable storage media” is used. The term “non-transitory” should be construed to exclude only those types of transitory media that were found to fall outside the scope of patentable subject matter in the Federal Circuit decision of In re Nuijten, 500 F.3d 1346 (Fed. Cir. 2007).

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a first digital image that depicts a first aerial view of a first area of a setting, the first digital image having a first center point that corresponds to a first coordinate within the setting;
obtaining a second digital image that depicts a second aerial view of a second area of the setting, the second digital image having a second center point that corresponds to a second coordinate within the setting, the second coordinate being laterally offset from the first coordinate by a target offset;
determining an overlapping area where the first area and the second area overlap;
obtaining a third digital image based on the overlapping area, the first digital image, and the second digital image;
generating a first-eye image of a stereoscopic image of the setting based on the first digital image;
generating a second-eye image of the stereoscopic image based on the third digital image; and
presenting the stereoscopic image on a screen of an electronic device.

2. The method of claim 1, wherein:
generating the first-eye image based on the first digital image includes using the first digital image as the first-eye image; and
generating the second-eye image based on the third digital image includes using the third-digital image as the second-eye image.

3. The method of claim 1, further comprising adjusting a resolution of the third digital image based on a screen resolution of a screen such that the resolution is greater than or equal to the screen resolution.

4. The method of claim 3, wherein adjusting the resolution includes obtaining additional information regarding the overlapping area.

5. The method of claim 1, further comprising:
obtaining the first digital image based on a determined first orientation such that the first digital image depicts the first area according to the first orientation; and
obtaining the second digital image such that the second digital image depicts the second area according to a second orientation that is substantially parallel to the first orientation.

6. The method of claim 1, further comprising:
obtaining the first digital image based on a determined first orientation such that the first digital image depicts the first area according to the first orientation; and
obtaining the second digital image such that the second digital image depicts the second area according to a second orientation that is rotated with respect to the first orientation by a target rotation angle.

7. The method of claim 1 further comprising:
determining a direction of travel of an object in the setting;
determining a first orientation based on the direction of travel; and
obtaining the first digital image based on the first orientation such that the first digital image depicts the first area according to the first orientation.

8. The method of claim 7, wherein the direction of travel is determined based on a global positioning system (GPS) coordinate obtained for the object.

9. The method of claim 1, further comprising:
determining a location of an object in the setting; and
obtaining the first digital image based on the location of the object such that the first area includes the location of the object.

10. The method of claim 9, wherein obtaining the first digital image based on the location of the object is such that the location of the object corresponds to the first center point.

11. The method of claim 1, further comprising:
obtaining the first digital image such that the first digital image represents a first tilted aerial view of the setting; and
obtaining the second digital image such that the second digital image represents a second tilted aerial view of the setting.

12. Non-transitory computer-readable storage media including computer executable instructions configured to cause a system to perform operations, the operations comprising:
obtaining a first digital image that depicts a first aerial view of a first area of a setting, the first digital image having a first center point that corresponds to a first coordinate within the setting;
obtaining a second digital image that depicts a second aerial view of a second area of the setting, the second digital image having a second center point that corresponds to a second coordinate within the setting, the second coordinate being laterally offset from the first coordinate by a target offset;
determining an overlapping area where the first area and the second area overlap;
obtaining a third digital image based on the overlapping area, the first digital image, and the second digital image;
generating a first-eye image of a stereoscopic image of the setting based on the first digital image;
generating a second-eye image of the stereoscopic image based on the third digital image; and
presenting the stereoscopic image on a screen of an electronic device.

13. The non-transitory computer-readable storage media of claim 12, wherein:
generating the first-eye image based on the first digital image includes using the first digital image as the first-eye image; and
generating the second-eye image based on the third digital image includes using the third-digital image as the second -eye image.

14. The non-transitory computer-readable storage media of claim 12, wherein the operations further comprise adjusting a resolution of the third digital image based on a screen resolution of a screen such that the resolution is greater than or equal to the screen resolution.

15. The non-transitory computer-readable storage media of claim 12, wherein the operations further comprise:
obtaining the first digital image based on a determined first orientation such that the first digital image depicts the first area according to the first orientation; and
obtaining the second digital image such that the second digital image depicts the second area according to a second orientation that is substantially parallel to the first orientation.

16. The non-transitory computer-readable storage media of claim 12, wherein the operations further comprise:
obtaining the first digital image based on a determined first orientation such that the first digital image depicts the first area according to the first orientation; and
obtaining the second digital image such that the second digital image depicts the second area according to a second orientation that is rotated with respect to the first orientation by a target rotation angle.

17. The non-transitory computer-readable storage media of claim 12, wherein the operations further comprise:
determining a direction of travel of an object in the setting;
determining a first orientation based on the direction of travel; and
obtaining the first digital image based on the first orientation such that the first digital image depicts the first area according to the first orientation.

18. The non-transitory computer-readable storage media of claim 12, wherein the operations further comprise:
determining a location of an object in the setting; and
obtaining the first digital image based on the location of the object such that the first area includes the location of the object.

19. The non-transitory computer-readable storage media of claim 18, wherein obtaining the first digital image based on the location of the object is such that the location of the object corresponds to the first center point.

20. The non-transitory computer-readable storage media of claim 12, wherein the operations further comprise:
obtaining the first digital image such that the first digital image represents a first tilted aerial view of the setting; and
obtaining the second digital image such that the second digital image represents a second tilted aerial view of the setting.
